(19) United States
(12) Patent Application Publication
(10) Pub. No.: US 2011/0047474 A1
(43) Pub. Date: Feb. 24, 2011

(54) REMOTE CONTROL METHOD AND REMOTE CONTROL SYSTEM USING THE SAME

(75) Inventors: Ju-yun Sung, Yongin-si (KR); Hee-jeong Choo, Anyang-si (KR); Keum-koo Lee, Seongnam-si (KR); Ji-young Kwahk, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/860,480

(22) Filed: Aug. 20, 2010

(30) Foreign Application Priority Data
Aug. 21, 2009 (KR) 10-2009-0077500

(51) Int. Cl. G06F 3/01

(52) U.S. Cl. 715/740

(57) ABSTRACT

A remote control system and a remote control method are provided. The remote control system includes a first device, and a second device that controls the first device using an image generated based on a manipulation means provided for manipulation of the first device. Accordingly, it is possible for a user to remotely use the home device, and can feel the same effect as that felt when the user directly manipulates the home device at home.

### PRIORITY

This application claims priority under 35 U.S.C. §119(a) to Korean Patent Application No. 10-2009-0077500, filed on Aug. 21, 2009, in the Korean Intellectual Property Office, the disclosure of which is incorporated herein by reference.

### BACKGROUND OF THE INVENTION

1. Field of the Invention

The present invention relates generally to a remote control method and a remote control system using the same, and more particularly, to a remote control method and a remote control system using the same that use a GUI (Graphic User Interface) generated based on a UI (User Interface) of a controlled device.

2. Description of the Related Art

Generally, a remote control system means a system for controlling a device at long range. With the development of such a remote control system, a user can control a device more conveniently as being less restricted by space.

However, in order to heighten the utility and practicability of such a remote control system, there are many problems to be additionally solved. One of such problems is that there is a difference in the sense for the real between a method for direct manipulation of the device and a method for remote manipulation through another device.

In particular, in the case of manipulating a controlled device typically using a control device such as a relationship between a TV (controlled device) and a remote controller (control device), there is no problem, while in the case where the control-controlled relationship is not determined such a relationship between MP3P (controlled device) and a notebook computer (control device) or both the relationships coexist, a problem may occur.

That is, in the case of manipulating a TV by a mobile phone, a user should feel great inconvenience in manipulation due to the difference between the manipulation of TV by a mobile phone and the direct manipulation of TV or the manipulation of TV through the remote controller.

### SUMMARY OF THE INVENTION

The present invention has been made to address at least the above problems and/or disadvantages and to provide at least the advantages described below. Accordingly, an aspect of the present invention provides a remote control method and a remote control system using the same that facilitate remote control of a device at home.

According to one aspect of the present invention, a remote control system includes a first device, and a second device that controls the first device using an image generated based on a manipulation means provided for manipulation of the first device.

Here, the manipulation means provided for manipulation of the first device may be a UI provided in the first device or a UI provided in a control device that controls the first device as a controlled device.

The image is a GUI image that is graphics of the manipulation means or a GUI image that is displayed on a screen of the first device through manipulation of the manipulation means, and the second device controls the first device by manipulating the GUI image.

Also, the second device is provided with a touch screen on which the GUI image is displayed, and when a touch for the GUI image is input, the second device generates the same control signal as a control signal generated when the manipulation means is input and transmits the generated control signal to the first device to control the first device.

In the case where a plurality of manipulation means are provided, the GUI image is generated as many as the number that corresponds to the plurality of manipulation mean, and the respective manipulation means correspond to the respective GUI images.

Also, a control signal transferred to the first device through manipulation of the manipulation means may be the same as a control signal that is transferred to the first device through selection of the image through the second device.

The image is generated from the first device and is transferred to the second device.

If there is a transmission request for the image from the second device, the image is transferred from the first device to the second device.

Also, the first device is a home device provided at home, the second device is a portable device that a user can carry outside of home, and the second device remotely controls the first device using a wireless communication.

According to another aspect of the present invention, a remote control method of a first device using a first device includes generating an image based on a manipulation means provided to manipulate the first device, and the second device controlling the first device using the image.

Accordingly, it is possible for a user to remotely use the home device, and can feel the same effects as those felt when the user directly manipulates the home device at home.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a remote control process according to an embodiment of the present invention;

FIG. 2 is a diagram illustrating a state where EPG is received in a mobile phone;

FIG. 3 is a diagram illustrating a state where a broadcasting program for reserved recording is selected through a mobile phone;

FIG. 4 is a diagram illustrating a state where a reminder for reporting a completion of reserved recording is received in a mobile phone;

FIG. 5 is a diagram illustrating a remote control process according to another embodiment of the present invention;

FIG. 6 is a diagram illustrating a remote control process according to still another embodiment of the present invention;

FIG. 7 is a diagram illustrating RUI for remote control;

FIG. 8 is a diagram illustrating RUI for remote reserved recording;

FIG. 9 is a diagram illustrating a remote control process according to still another embodiment of the present invention;

FIG. 10 is a diagram illustrating a remote control process according to still another embodiment of the present invention;

FIG. 11 is a diagram illustrating a state where a broadcasting time change message is received in a mobile phone;

FIG. 12 is a diagram illustrating a remote control process according to still another embodiment of the present invention;

FIG. 13 is a diagram illustrating a state where a reserved recording completion message is received in a mobile phone;

FIG. 14 is a diagram illustrating a state where a reservation-recorded broadcasting program is reproduced through a mobile phone;

FIG. 15 is a diagram illustrating an operation flow for remote control;

FIG. 16 is a block diagram illustrating the configuration of a mobile phone; and

FIG. 17 is a block diagram illustrating the configuration of a TV.

### DETAILED DESCRIPTION OF EMBODIMENTS OF THE PRESENT INVENTION

Embodiments of the present invention are described in detail with reference to the accompanying drawings.

In the following description, the same or similar reference numerals may be used for the same or similar elements when they are illustrated in different drawings. Detailed descriptions of constructions or processes known in the art may be omitted to avoid obscuring the subject matter of the present invention.

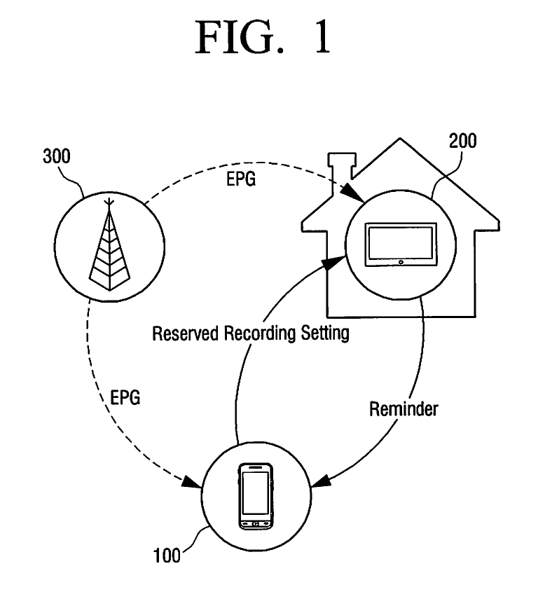

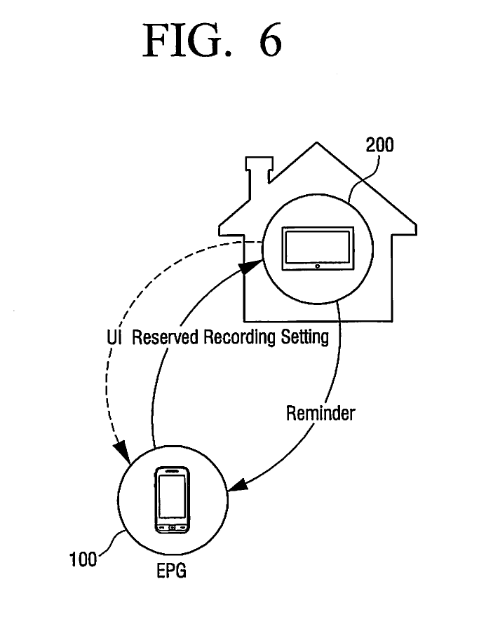

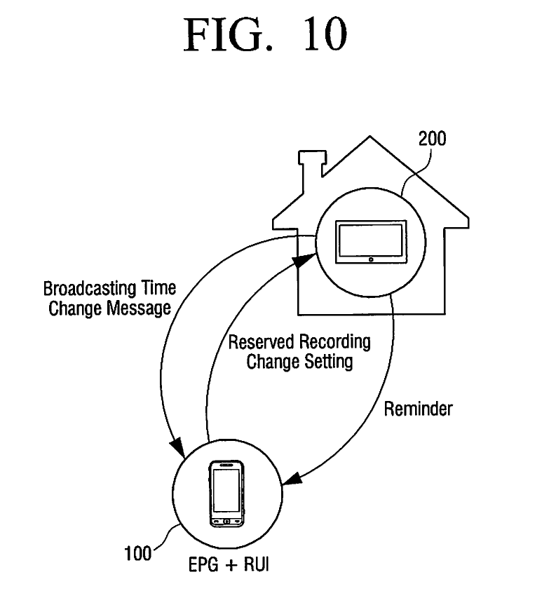

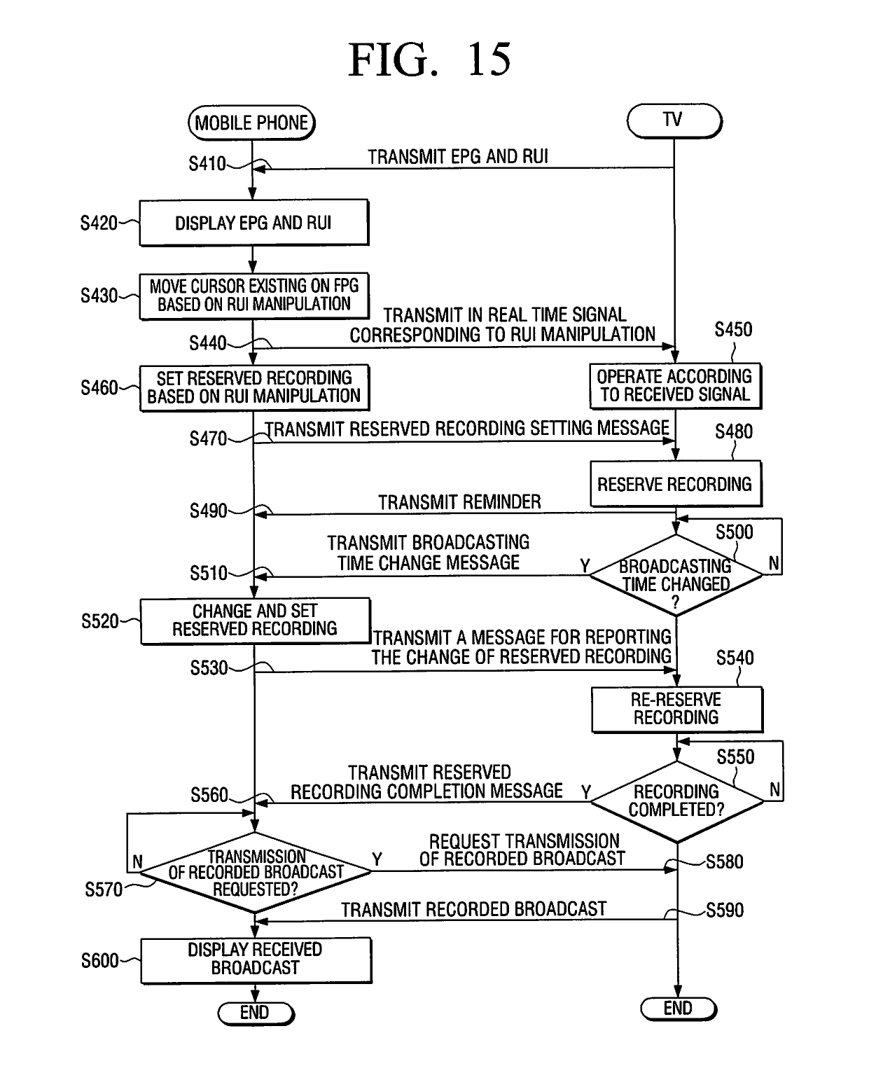

In particular, with reference to FIGS. 1 to 5, a brief operation of the remote control system will be described with reference to FIGS. 1 to 5, and then with reference to FIGS. 6 to 9, a method of performing a reserved recording through a RUI (Remote User Interface) will be described. Also, with reference to FIGS. 10 to 14, examples of separate functions which are possible under the remote control system will be described, and with reference to FIGS. 15 to 17, a process and configuration for the remote control will be described.

### [Remote Control System for Broadcast Recording]

Hereinafter, with reference to FIGS. 1 to 5, the brief operation of the remote control system will be described.

FIG. 1 is a diagram illustrating a remote control process according to an embodiment of the present invention. The remote control system according to an embodiment of the present invention can remotely control a home device, and thus a user can easily use the home device without being restricted by space.

As illustrated, the remote control system includes a mobile phone 100 and a TV 200.

The mobile phone 100 is a kind of portable phone that a user carries. In addition to the final purpose for a call with another communication subscriber, the mobile phone 100 is used for the additional purpose for remote control of devices provided at home.

TV 100 is a kind of fixed device mounted in a fixed place at home. In addition to the final purpose for providing a broadcasting program to a user, the TV 100 is used for the additional purpose for remote control of devices provided at home.

FIG. 1 shows an example of remote control of the devices provided at home. A home TV 200 is controlled using a mobile phone 100, and the recording of a broadcasting program is remotely reserved.

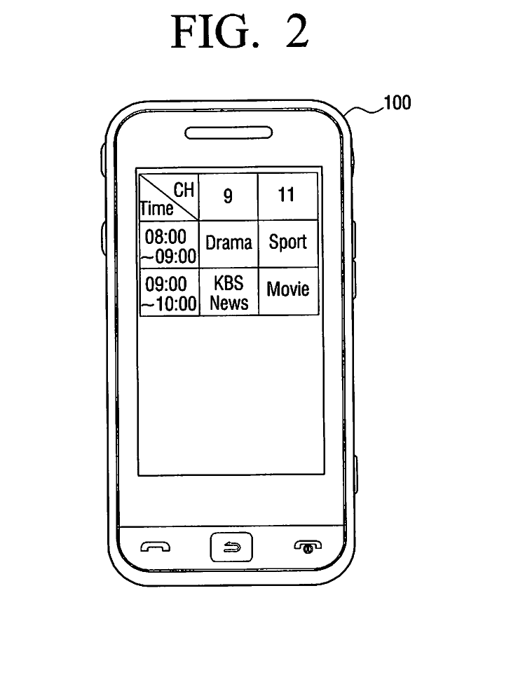

For the remote reserved recording, the mobile phone 100 receives an EPG (Electronic Program Guide) from a broadcasting state 300, and makes it possible to confirm information on any channel, time zone, broadcast, and the like. Such contents are illustrated in FIG. 2.

FIG. 2 is a diagram illustrating a state where EPG is received in a mobile phone. As illustrated, if the EPG is received from a broadcasting station 300, the received EPG is displayed on a screen of the mobile phone 100, and a user can prepare for reserved recording by confirming the broadcasting programs by channels and time zones through the mobile phone 100.

The EPG may be made to be transmitted from the broadcasting state 300 to the mobile phone in a predetermined period, or to be transmitted when a user's EPG transmission request is made.

Referring again to FIG. 1, in the same manner as the mobile phone, the TV 200 receives the EPG from the broadcasting station 300. Although not illustrated in the drawing, the TV 200 also receives a broadcasting program by channels together with the EPG.

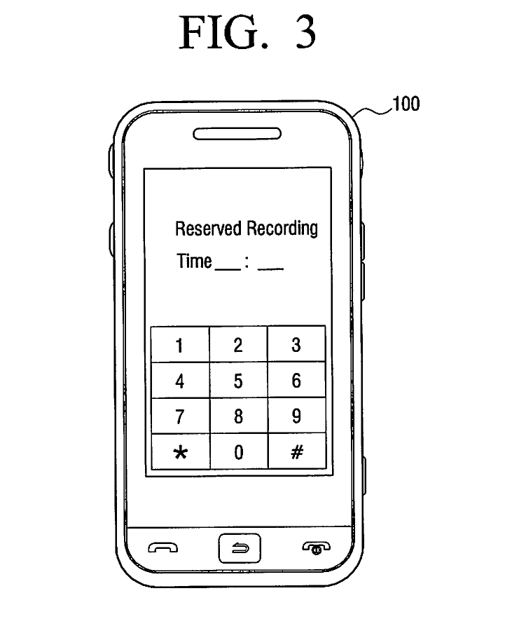

On the other hand, if the EPG is received, the user can make a reserved recording for the broadcasting program with reference to the received EPG. A screen for the reserved recording is shown in FIG. 3.

FIG. 3 is a diagram illustrating a state where a broadcasting program for reserved recording is selected through a mobile phone 100.

As illustrated in FIG. 3, the user, after confirming the EPG, can make the screen for the reserved recording displayed on the mobile phone 100 and input corresponding time for the reserved recording using a keypad displayed on the screen. Accordingly, the time zone where the user desires the reserved recording is selected.

Although not illustrated, the user may select a channel by inputting a channel number using the key pad displayed on the screen, or may select a broadcasting program through upward, downward, left, and right movement of a cursor.

In this embodiment of the present invention, it is exemplified that the mobile phone 100 operates in a touch screen type and a keypad is displayed on the screen in the touch screen method. However, the present invention can be applied in the same manner even in the case where a separate mechanical keypad or an electronic keypad, rather than the touch screen, is provided.

Referring again to FIG. 1, if the user selects a broadcasting program subject to the remote reserved recording through the TV 200 at home, a control command for setting the reserved recording of a specified program in a specified time zone through a specified channel is transmitted to the TV 200 through the mobile phone 100 that the user possesses.

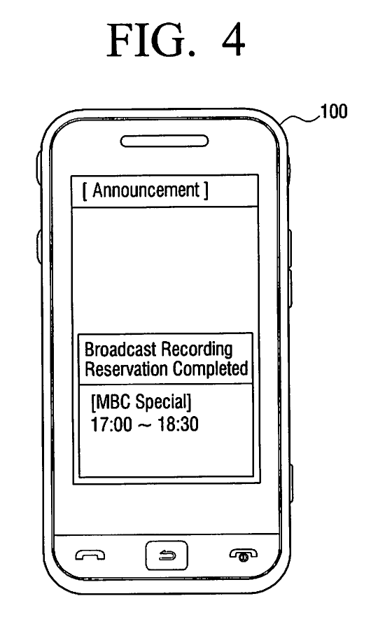

The TV 200 performs a reserved recording setting operation for the specified program in the specified time zone through the specified channel designated by the user on the basis of the control command received from the mobile phone 100. Then, the TV 200 transmits a reminder reporting that the setting of the reserved recording has been normally performed to the mobile phone 100. The contents of such a reminder are illustrated in FIG. 4.

FIG. 4 is a diagram illustrating a state where a reminder for reporting a completion of reserved recording is received in a mobile phone 100. As illustrated, the user can recognize whether the reserved recording has been normally performed by confirming the reminder received from the TV 200.

As described above, the user can remotely control the TV 200 that is the device provided at home using the mobile phone 100 that is a portable device, and thus can easily use the home device.

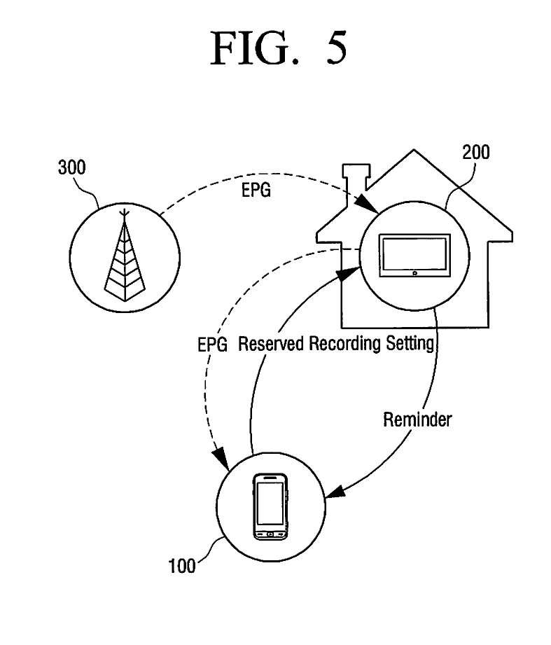

On the other hand, FIG. 5 is a diagram illustrating a remote control process according to another embodiment of the present invention. The remote control system according to this embodiment can remotely control the home device, and thus the user can easily use the home device without being restricted by space. Hereinafter, duplicate contents in FIGS. 1 to 4 will be omitted, and the explanation will be made around the difference between the two embodiments.

The TV 200 receives the EPG from the broadcasting station 300.

On the other hand, since the EPG has been transmitted from the broadcasting station 300 to the TV 200, the mobile phone can use the EPG that has been transmitted to and stored in the TV 200. That is, the mobile phone 100 transfers the request for the EPG transmission to the TV 200, receives the EPG from the TV 200, and can confirm the information on any channel, time zone, and broadcast through the received EPG. The EPG may be transmitted from the TV 299 to the mobile phone 100 in a predetermined period, or may be transmitted in the case where a user's EPG transmission request is made.

Accordingly, the user can confirm the information on the channel, time zone, and broadcast using the EPG that is transmitted from the TV 200, which the user does not carry, to the mobile phone 100, which the user carries, and through the confirmed information, the user can set the reserved recording by transmitting the control signal for setting the preserved recording of a specified program in the specified time zone through the specified channel.

Through the above-described method, the user can easily use the home device at long range.

### [RUI Providing Method for Reserved Recording]

Hereinafter, with reference to FIGS. 6 to 9, a method of performing the reserved recording through the RUI (Remote User Interface).

FIG. 6 is a diagram illustrating a remote control process according to still another embodiment of the present invention. In this embodiment, it is assumed that the mobile phone 100 has already received the EPG through the system as described above with reference to FIG. 1 or 5 or other systems.

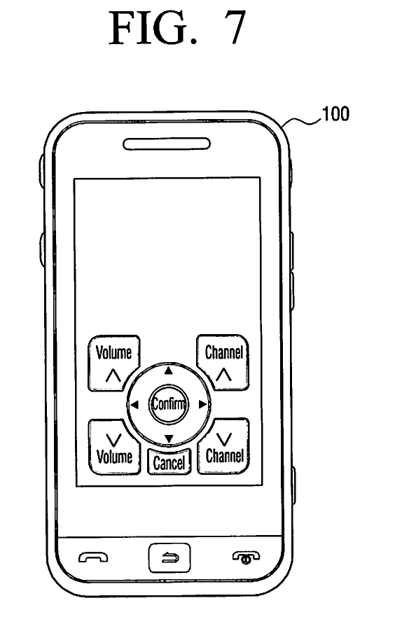

In a state where the mobile phone 100 has received the EPG, the mobile phone 100 may receive a UI (User Interface) that is used to manipulate the TV 200 from the TV 200 in order to perform reserved recording through the EPG. This UI is a GUI (Graphic User Interface) that includes graphics having the same shape and type as buttons of a remote controller (not illustrated) that is used when the TV 200 is actually manipulated, the contents of which is illustrated in FIG. 7.

FIG. 7 is a diagram illustrating RUI for remote control. As illustrated, on the screen of the mobile phone 100, graphics having the same shape as the buttons of the remote controller, which are used when the TV 220 is manipulated, as GUI.

Since the mobile phone 100 operates in a touch screen type, a user can manipulate the TV 200 by selecting graphic buttons (e.g. volume [symbol] , volume [symbol] , channel [symbol] , and channel [symbol] ) displayed on the screen of the touch screen. That is, if the user selects one of the graphic buttons displayed on the screen, a control signal that corresponds to the selected graphic button is generated and wirelessly transmitted to the TV 200, and the TV 200 operates based on the received control signal.

Accordingly, even if the user is not at home, he/she can remotely control the TV 200 that exists at home by manipulating the GUI that is displayed on the screen of the mobile phone 100, and this can give the same effects to the TV 200 as those obtained when the remote controller of the TV 200 that exists at home is manipulated.

As described above, the TV 200 can be remotely controlled through the GUI displayed on the screen of the mobile phone 100, and this GUI is called RUI.

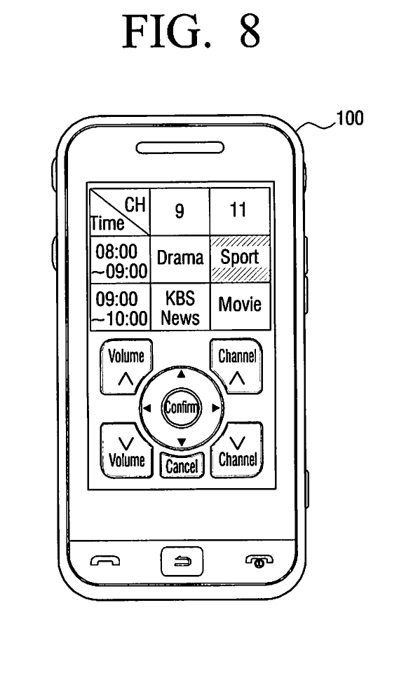

On the other hand, for the reserved recording, both the EGP and the RUI can be simultaneously displayed on the screen of the mobile phone 100 as shown in FIG. 8. FIG. 8 is a diagram illustrating the RUI for the remote reserved recording.

As described above, since the EPG and the RUI are simultaneously displayed, the user can feel the same effects as those felt when the user performs the reserved recording of a broadcasting program actually using the remote controller of the TV 200 at home.

Also, since both the EPG and the RUI are displayed together, as described above with reference to FIG. 3, it is not required for the user to directly input the time or the channel number for the reserved recording. That is, the user can select one broadcasting program among broadcasting programs displayed through the EPG only by touching a direction key on the RUI.

For example, a channel is selected by touching a left/right direction key, and a program time zone is selected by touching a up/down direction key among the direction keys. Also, if a broadcasting program for the reserved recording is selected through the touch of a direction key, the user can confirm the reserved recording of the selected broadcasting program through only the touch manipulation of a confirmation key on the RUI.

As described above, once the reserved recording of a broadcasting program is confirmed, the mobile phone 100 transmits a reserved recording command for the confirmed broadcasting program to the TV 200, and the TV 200 reserves the broadcasting program based on the received reserved recording command.

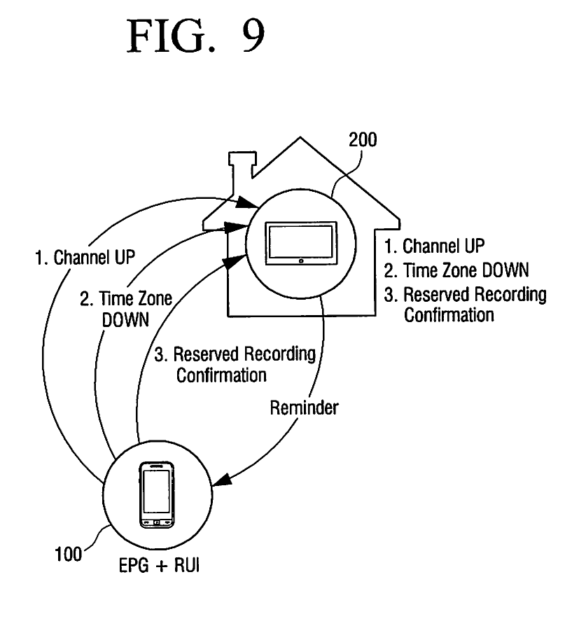

On the other hand, as described above, although it is exemplified that the reserved recording command that is finally confirmed through the RUI is transmitted to the TV 200, the broadcasting program can be reserved by making a signal or a command that corresponds to the selected graphic button transferred to the TV 200 whenever the graphic button is selected one by one. The detailed explanation thereof will be made with reference to FIG. 9

FIG. 9 is a diagram illustrating a remote control process according to still another embodiment of the present invention. As illustrated, in this embodiment, it is assumed that the mobile phone 100 has already received the EGP and the RUI.

As described above, the mobile phone 100 can perform the reserved recording of a broadcasting program through the EGP and the RUI displayed on the screen. However, in this embodiment, a signal or a command that corresponds to a selected graphic button is transferred to the TV 200 whenever a graphic button on the RUI is selected one by one.

First, if the user touches a right direction key on the RUI, a cursor that is positioned on a broadcasting program of a specified channel on the EPG of the mobile phone 100 moves to the broadcasting program of the channel positioned in the right direction to correspond to the operation of touching the right direction key. Also, at the same time, a “channel UP” signal that corresponds to the operation of touching the right direction key is transmitted to the TV 200. Accordingly, the TV 200 receives the “channel UP” signal and performs an operation that corresponds to the received “channel UP” signal.

Also, if the user touches a down direction key on the RUI, the cursor that is positioned on a specified time zone on the EPG of the mobile phone 100 moves to the broadcasting program of the time zone positioned in the downward direction to correspond to the operation of touching the down direction key. Also, at the same time, a “time zone DOWN” signal that corresponds to the operation of touching the down direction key is transmitted to the TV 200. Accordingly, the TV 200 receives the “time zone DOWN” signal and performs an operation that corresponds to the received “time zone DOWN” signal.

Last, if the user touches the confirmation key on the RUI, the reservation of the broadcasting program on which the cursor is positioned on the EPG of the mobile phone 100 is completed to correspond to the operation of touching the confirmation key. Also, at the same time, a “reserved recording confirmation” signal that corresponds to the operation of touching the confirmation key is transmitted to the TV 200. Accordingly, the TV receives the “reserved recording confirmation” signal, and performs an operation that corresponds to the received “reserved recording confirmation” signal.

Once the reserved recording is confirmed through the above-described operation, the TV 200 transmits a reminder reporting that the reserved recording has been normally set to the mobile phone 100.

As described above, through the interlocking between the manipulation of the mobile phone 100 and the actual manipulation of the TV 200, the user can feel the same effects as those felt when the user performs the reserved recording of a broadcasting program actually using the remote controller of the TV 200 at home.

[Separate Functions under Remote Control System]

Hereinafter, with reference to FIGS. 10 to 14, examples of separate functions which are possible under a remote control system will be described.

FIG. 10 is a diagram illustrating a remote control process according to still another embodiment of the present invention. As illustrated, in this embodiment, it is assumed that the mobile phone 100 has already received the EGP and the RUI.

As described above, if the setting of the reserved recording of the broadcasting program through the mobile phone 100 is completed, the TV 200 transmits a reminder to the mobile phone 100, and proceeds to the reserved recording after waiting for the reserved recording time.

However, if the broadcasting time of the broadcasting program of which the reserved recording has been set is changed, the TV 200 may receive from the user information on whether to perform the reserved recording according to the changed broadcasting time. This is to consider the point that at the changed reserved recording time, a user may directly view the broadcast through the TV 200 at home without the necessity of separate recording of the broadcast.

Accordingly, the TV 200 sends a message for reporting the change of the broadcasting time to the user. Specifically, in order to send the broadcasting time change message to the user, the TV 200 extracts information on the mobile phone 100 that is a device to which the existing reserved recording setting has been input, and based on the extracted information, transmits the broadcasting signal change message to the mobile phone 100.

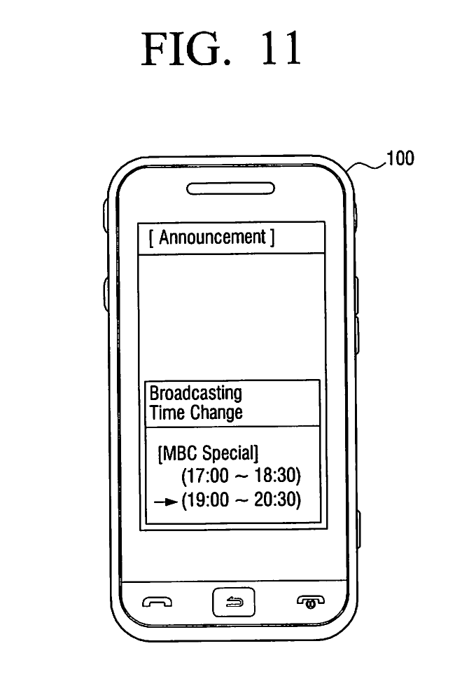

The contents of the broadcasting time change message are described in FIG. 11. FIG. 11 is a diagram illustrating a state where a broadcasting time change message is received in a mobile phone 100.

As described above, the TV 200 transmits information on the changed broadcasting time, together with information on the fact that the broadcasting time has been changed, to the mobile phone 100 as the broadcasting time change message, and the mobile phone 100 displays the received broadcasting time change message on the screen to provide the message to the user.

Referring again to FIG. 10, the user can set the change of the reserved recording based on the broadcasting time change message that is displayed on the screen of the mobile phone 100, and the mobile phone 100 transmits a signal for setting the changed reserved recording to the TV 200, and the TV 200 retransmits a reminder for setting the changed reserved recording to the mobile phone 100.

Accordingly, the user's convenience in performing the reserved recording in the case where the broadcasting time has been changed is increased.

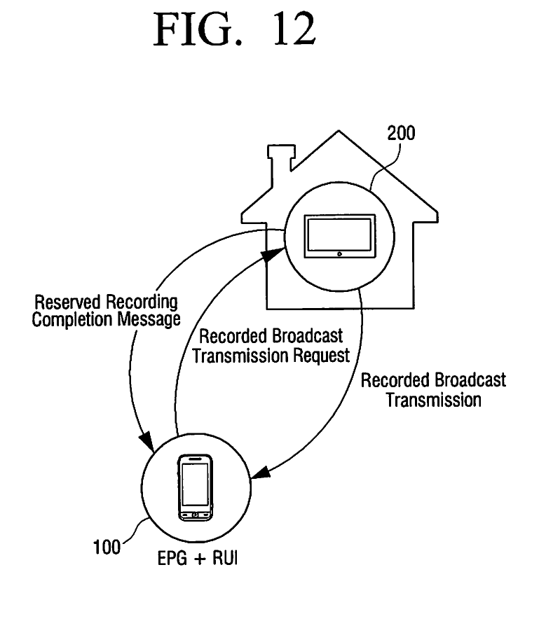

FIG. 12 is a diagram illustrating a remote control process according to still another embodiment of the present invention. As described above, in this embodiment, it is assumed that the mobile phone 100 has already received the EPG and the RUI.

As described above, if the setting of the reserved recording of the broadcasting program through the mobile phone 100 is completed, the TV 200 transmits a reminder to the mobile phone 100, and proceeds to the reserved recording after waiting for the reserved recording time.

Thereafter, if the reserved recording is completed, the TV 100 transmits a message for reporting the completion of the reserved recording to the mobile phone 100. This is to consider the point that the user can confirm whether the reserved recording has been normally performed and the reservation-recorded broadcasting program can be viewed through the mobile phone 100.

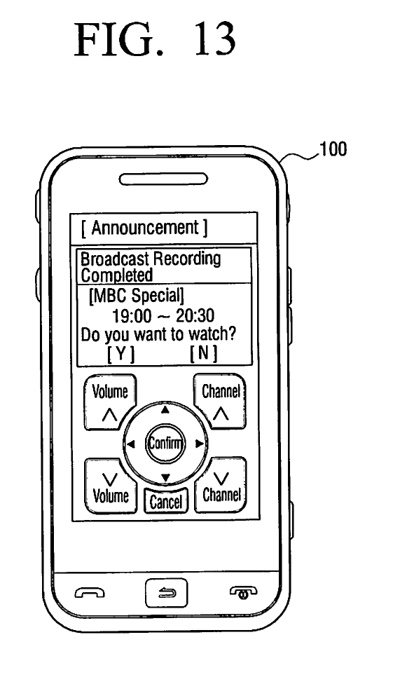

The contents of the message that indicates the completion of the reserved recording are shown in FIG. 13. FIG. 13 is a diagram illustrating a state where a reserved recording completion message is received in a mobile phone.

As described above, the TV 200 transmits information on whether to view the reservation-recorded broadcasting program, together with information that indicates the completion of the reserved recording, to the mobile phone 100 as a reserved recording completion message, and the mobile phone 100 displays the reserved recording completion message on the screen to provide the message to the user.

On the other hand, the user can view the broadcasting program of which the reserved recording has been completed by manipulating the RUI displayed on the screen of the mobile phone 100. That is, the user can transmit a signal for requesting transmission of the broadcasting program of which the reserved recording has been completed to the TV 200 by selecting “Y” from the information asking whether to view the recorded broadcasting program

As described above, if “Y” is selected through the RUI, as illustrated in FIG. 12, a signal for requesting transmission of the recorded broadcast is transmitted to the TV 200, and the TV 200 transmits the recorded broadcast to the mobile phone 100 based on the received signal.

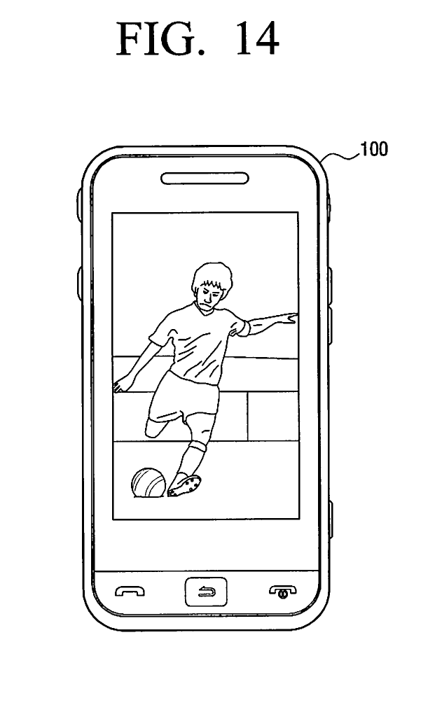

Accordingly, the user can view the reservation-recorded broadcasting program through the mobile phone 100. The contents thereof are shown in FIG. 14. FIG. 14 is a diagram illustrating a state where a reservation-recorded broadcasting program is reproduced through the mobile phone 100.

### [Operation Flow of Remote Control System and Configuration of Devices]

Hereinafter, the whole operation flow under the remote control system and the configuration of devices that constitute the remote control system will be described.

FIG. 15 is a diagram illustrating an operation flow for remote control.

First, the mobile phone 100 receives the EPG and the RUI from the TV 200 (S410). As described above, the EPG and the RUI may be received from the TV 200 if the mobile phone 100 separately requests the transmission of the EPG and the RUI, and even if no separate request is received. Also, the EPG can be received from the broadcasting station 300.

The mobile phone 100 displays the received EPG and RUI on the screen (S420), and moves the cursor existing on the EPG based the user's manipulation against the RUI displayed on the screen (S430). Signals corresponding to such RUI manipulations are generated in real time from the mobile phone 100, and transmitted to the TV 200 (S440), and the TV 200 operates based on the signals received in real time (S450).

Thereafter, if the reserved recording is set by the user based on the RUI displayed on the mobile phone 100 (S460), the mobile phone 100 transmits a reserved recording setting message to the TV 200 (S470). The TV 200 reserves the recording based on the received reserved recording setting message (S480), and if the recording is reserved, it transmits a reminder for reporting that the recording has been reserved to the mobile phone 100 (S490).

If it is determined that the broadcasting time for the broadcasting program of which the recording has been reserved is changed (“Y” in S500), the TV 200 transmits a message for reporting that the broadcasting signal has been changed to the mobile phone 100 (S510). The mobile phone 100 changes and sets the reserved recording by manipulating the RUI based on the received message (S520).

If the reserved recording is changed and set, the mobile phone 100 transmits a message for reporting the change of the reserved recording to the TV 200 (S530), and the TV 200 re-reserves the recording base on this (S540).

Also, if there is a transmission request for the recorded broadcast from the user through the mobile phone 100 (“Y” in S590), the mobile phone 100 requests the TV 200 to transmit the recorded broadcast (S580), and the TV 200 transmits the recorded broadcast to the mobile hone 100 (S590).

Through the above-described processes, the mobile phone 100 can view the broadcast recorded in the TV 200.

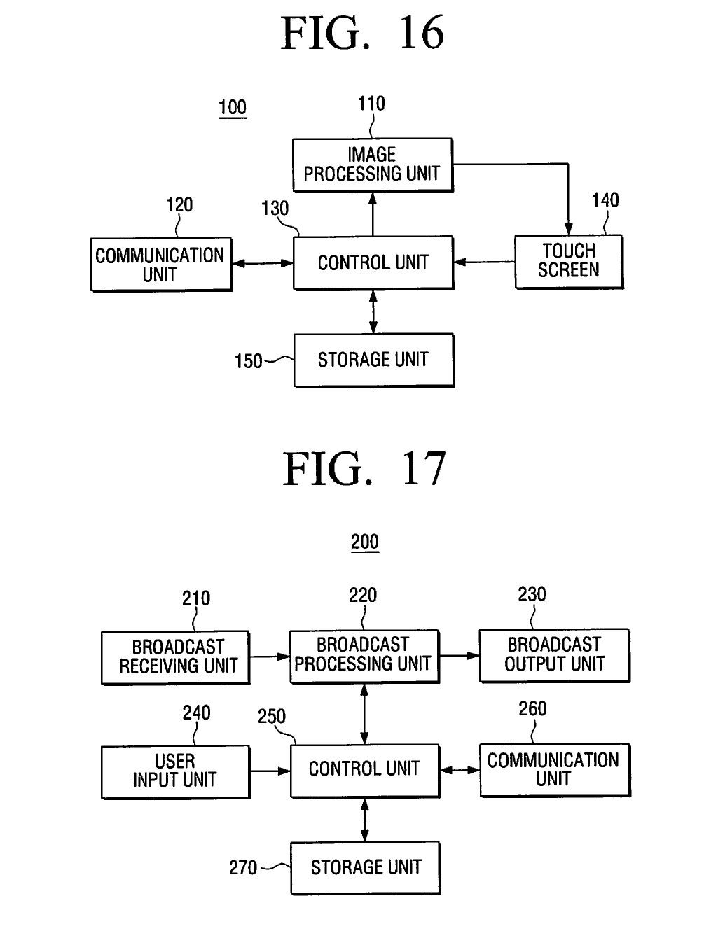

On the other hand, FIG. 16 is a block diagram illustrating the configuration of the mobile phone 100. In FIG. 16, only the configuration that is necessary for the explanation of the present invention is schematically illustrated. The mobile phone 100 includes an image processing unit 110, a communication unit 120, a control unit 130, a touch screen 140, and a storage unit 150.

The image processing unit 110 processes the received signals so that the EGP, RUI, and various kinds of messages are displayed on the screen of the touch screen 140 to be described later.

The communication unit 120 communicates with the controlled device such as the TV 200, transmits a remote control command such as the remote reserved recording or the like to the mobile phone 100, and receives information such as a reminder, EPG, RUI, broadcasting time change message, or the like, from the mobile phone 100.

The touch screen 140 displays the EPG, RUI, various kinds of messages as graphics, and transfers the user command input through the touch manipulation of the displayed graphics to the control unit 130.

The storage unit 150 stores information for the remote control and a program for operating the whole of the mobile phone 100. Information for the remote control includes the EPG received from the TV 200 or the broadcasting station 300, RUI and various kinds of messages received from the TV 200. The storage unit 270 may be implemented by a hard disc, a nonvolatile memory, and the like.

The control unit 130 controls the whole operation of the mobile phone 100 according to the user's manipulation that is transferred from the touch screen 140.

FIG. 17 is a block diagram illustrating the configuration of the TV 200. In this embodiment, the TV 200 is a kind of broadcast receiving device which receives a broadcasting program and program information and provides the same to the user. In FIG. 17, only the configuration that is necessary for the explanation of the present invention is schematically illustrated.

As illustrated in FIG. 17, the TV 200 includes a broadcast receiving unit 210, a broadcast processing unit 220, a broadcast output unit 230, a user input unit 240, a control unit 250, a communication unit 260, and a storage unit 270.

The broadcast receiving unit 210 selects any one of broadcasts which are received wirelessly or by wire through air or cable, and demodulates the selected broadcast.

The broadcast processing unit 220 performs a signal process for the broadcasting signal output from the broadcast receiving unit 210. Specifically, the broadcast processing unit 220 separates the broadcasting signal output from the broadcast receiving unit 210 into an audio signal, a video signal, and additional data. The additional data separated from the broadcasting signal is applied to the control unit 250. The additional data may be PSIP (Program and System Information Protocol) information. The PSIP information includes information on broadcasting programs, i.e. EPG.

The broadcast processing unit 220 decodes the audio signal separated from the broadcasting signal, and converts the decoded audio signal into an audio signal having a format that can be output through a speaker prepared in the TV 200.

Also, the broadcast processing unit 220 decodes the video signal separated from the broadcasting signal, and converts the decoded video signal into a video signal having a format that can be output through a display prepared in the TV 200. For this, the broadcast processing unit 220 performs a color signal process, scaling, and the like, of the decoded video signal.

In addition, the broadcasting processing unit 220 generates the GUI to be displayed on the display under the control of the control unit 250. Here, the GUI may include the above-described RUI, a GUI that makes it possible to receive a user's command related to the function performance of the TV 200, and a GUI for reporting the operation state of the TV 200.

The broadcast output unit 230 outputs video and audio corresponding to the video signal and the audio signal output from the broadcast processing unit 220 to provide the video and audio to the user.

The communication unit 260 communicates with the control device such as the mobile phone 100, receives the remote control command such as the remote reserved recording or the like from the mobile phone 100, and transmits the information such as the reminder, EPG, RUI, broadcasting time change message, or the like, to the mobile phone 100.

The storage unit 270 stores information regarding the broadcast program received from the broadcast receiving unit 210, information for remote-controlling, and programs for operating the TV 200. The information regarding the broadcast information includes the aforementioned EPG and the information for remote-controlling includes the aforementioned RUI.

The storage unit 270 stores reservation-recorded broadcasting programs according to the above-described reserved recording command. The storage unit 270 may be implemented by a hard disc, a nonvolatile memory, and the like.

The user input unit 240 transfers the user command input through manipulation buttons (not illustrated) prepared on a front panel of the remote controller (not illustrated) or the TV 200 to the control unit 150.

The control unit 250 controls the whole operation of the TV 200 according to a user command transferred from the user input unit 240 and a remote control command transferred from the mobile phone 100 through the communication unit 260.

### [Modified Embodiments for Remote Control]

Although it is assumed that the UI that is used to manipulate the TV 200 is provided from the TV 200 as described above, this is merely exemplary for convenience in explanation. Accordingly, it is not necessary that the UI is received from the TV 200, and the technical features of the present invention can be applied as they are even in the case where the UI is received from a home server (not illustrated) that has the TV 200 as a home device or in the case where the UI has already been stored in the mobile phone 100.

On the other hand, it is described that the mobile phone 100 may receive the RUI that is used to manipulate the TV 200 from the TV 200, and the RUI is a GUI that includes graphics having the same shape and type as buttons of the remote controller (not illustrated) that is used when the TV 200 is actually manipulated. However, this is also merely exemplary, and the RUI may also be a GUI that includes graphics having the same shape and type as the display of the TV 200 when the remote controller (not illustrated) is manipulated, rather than the shapes of the buttons of the remote controller (not illustrated).

In particular, the mobile phone 100 is operable in a touch screen type, and thus even if the GUI having the same shape as the display of the TV 200 is provided as the RUI, the user can feel the same effects as if the user manipulates the TV 200.

Also, although it is assumed that the reserved recording of the broadcasting program designated by the user is performed as it is and transmitted to the mobile phone 100 as described above, this is also merely exemplary for the convenience in explanation. Accordingly, the user can make it possible to chapter only a highlight portion of the recorded broadcasting program in the TV 200 and to transmit the highlight portion to the mobile phone 100 or to set the reserved recording so that only a highlight portion of the broadcasting program is chaptered and reservation-recorded. Examples of the highlight chaptering methods are as follows.

First is a method of chaptering a highlight based on the viewing rate totaled in real time by a viewing rate totaling institute. In this case, in consideration of a difference between the actual broadcasting time of the broadcasting program and the viewing rate totaling time, the TV 200 performs reserved recording of all the broadcasting programs, and chapters the highlights when the TV 200 transmits the broadcasting program to the mobile phone 100.

Second is a method of chaptering highlights by grasping point scoring scenes or point scoring chance scenes. For this, it is required for the TV 200 itself to select the point scoring scenes or point scoring change scenes. As an example for this, regions where a commentator's voice (audio) becomes loud may be selected through voice analysis of the broadcasting program or regions that are prior to the regions where the score is changed for a predetermined time may be selected through image analysis of the broadcasting program.

Last is a method of chaptering highlights based on information about regions related to “main scenes of the next-time broadcast” which was broadcast as the last portion of the previous broadcast. This refers to the case where the previous broadcast programs are stored in the TV 200.

On the other hand, in order to chapter only the highlight portions of the broadcasting program reservation-recorded in the TV 200 and transmit the highlight portions to the mobile phone 100, it is also possible to chapter only the highlight portions of the broadcasting program during the reserved recording and to record the highlight portions only.

From the foregoing, examples of remote control have been described based on the reserved recording of the broadcasting program and example of a remote control system have been described based on the mobile phone 100 that is the remote control device and the TV 200 that is the device for the reserved recording of the broadcasting program. However, they are also merely exemplary, and the features of the present invention can be applied as they are even in the case where a different type of remote control or a different remote control system is used.

While the invention has been shown and described with reference to certain embodiments thereof, it will be understood by those skilled in the art that various changes in form and detail may be made therein without departing from the spirit and scope of the invention, as defined by the appended claims.

What is claimed is:

1. A remote control system comprising:
a first device; and
a second device that controls the first device using an image generated based on a manipulation means provided for manipulation of the first device.

2. The remote control system as claimed in claim 1, wherein the manipulation means provided for manipulation of the first device is a UI provided in the first device or a UI provided in a control device that controls the first device as a controlled device.

3. The remote control system as claimed in claim 1, wherein the image is a GUI image that is graphics of the manipulation means or a GUI image that is displayed on a screen of the first device through manipulation of the manipulation means, and
the second device controls the first device by manipulating the GUI image.

4. The remote control system as claimed in claim 3, wherein the second device is provided with a touch screen on which the GUI image is displayed, and when a touch for the GUI image is input, the second device generates the same control signal as a control signal generated when the manipulation means is input and transmits the generated control signal to the first device to control the first device.

5. The remote control system as claimed in claim 3, wherein, in the case where a plurality of manipulation means are provided, the GUI image is generated as many as the number that corresponds to the plurality of manipulation mean, and the respective manipulation means correspond to the respective GUI images.

6. The remote control system as claimed in claim 1, wherein a control signal transferred to the first device through manipulation of the manipulation means is the same as a control signal that is transferred to the first device through selection of the image through the second device.

7. The remote control system as claimed in claim 1, wherein the image is generated from the first device and is transferred to the second device.

8. The remote control system as claimed in claim 7, wherein if there is a transmission request for the image from the second device, the image is transferred from the first device to the second device.

9. The remote control system as claimed in claim 1, wherein the first device is a home device provided at home and the second device is a portable device that a user can carry outside of home, and
the second device remotely controls the first device using a wireless communication.

10. A remote control method of a first device using a second device comprising:
generating an image based on a manipulation means provided to manipulate the first device, and
the second device controlling the first device using the image.
